(19) United States
(12) Patent Application Publication
(10) Pub. No.: US 2015/0316437 A1
(43) Pub. Date: Nov. 5, 2015

(54) PRESSURE GAUGE TESTING DEVICE

(71) Applicant: LACEY INSTRUMENTATION INC., Collingwood (CA)

(72) Inventor: Timothy Edward LACEY, Collingwood (CA)

(73) Assignee: LACEY INSTRUMENTATION INC., Collingwood (CA)

(21) Appl. No.: 14/695,270

(22) Filed: Apr. 24, 2015

Related U.S. Application Data
(60) Provisional application No. 61/988,347, filed on May 5, 2014.

(30) Foreign Application Priority Data
May 5, 2014 (CA) 2851440

(51) Int. Cl. G01L 17/00

(52) U.S. Cl. CPC G01L 17/00

(57) ABSTRACT

A pressure gauge testing device comprising an air supply inlet; a pressure regulator connected to the air supply inlet; an isolation valve connected to the pressure regulator; a valve stem fitting connected to the isolation valve; and a pressure gauge for reading the pressure between the isolation valve and the valve stem fitting is disclosed. The device connects between an air source and a pressure gauge to test the accuracy of the pressure reading on the gauge. The device can also be used to measure tire pressure directly with the addition of an air connection fitting in parallel with the valve stem fitting/connection.

### TECHNICAL FIELD

The present disclosure relates to a device and method of using same to test the accuracy of a Tire pressure gauge.

### BACKGROUND

Hand held tire pressure gauges are relied upon by mechanics and other operators of devices that use pneumatic tires to test the pressure of tires of vehicles. Inflating tires to the manufacturers recommended pressure results in optimum performance of the tires, resulting in less wear on the tires and better fuel efficiency of the vehicle. It also allows the vehicle to safely handle all the conditions it is exposed to.

An underinflated tire can't maintain its shape and becomes flatter than intended while in contact with the road. If a vehicle's tires are underinflated it could lead to tire failure. Additionally, the tire's tread life could be reduced by as much as 25%. Lower inflation pressure will allow the tire to deflect (bend) more as it rolls. This will build up internal heat, increase rolling resistance and cause a reduction in fuel economy. Lower inflation also results a significant loss of steering precision and cornering stability.

An overinflated tire is stiff and unyielding and the size of its footprint in contact with the road is reduced. If a vehicle's tires are overinflated by 6 psi, they could be damaged more easily when running over potholes or debris in the road. Higher inflated tires cannot isolate road irregularities well, causing them to ride harsher.

Tire pressure should be checked with a quality air gauge as the inflation pressure cannot be accurately estimated through visual inspection. However, if the pressure gauge used is not accurate, the tire tested using the air pressure gauge will not be properly inflated. Any measuring instrument requires calibration initially and verification or calibration over time. Presently, there is no convenient way to verify if an air pressure gauge is reading correctly/or needs calibration/or replacement.

### SUMMARY

In one aspect, there is provided a pressure gauge testing device comprising: an air supply inlet; a pressure regulator connected to the air supply inlet; an isolation valve connected to the pressure regulator; a valve stem fitting connected to the isolation valve; and a pressure gauge for reading the pressure between the isolation valve and the valve stem fitting.

In an embodiment, the air supply inlet comprises a quick connect connector. In some embodiments, the air supply inlet comprises an automotive type M quick connect connector.

In other embodiments, the air supply inlet is a threaded pipe.

In some embodiments, the air inlet comprises a connecter rated for at least 100 PSIg.

In some embodiments, the device further comprises a female air fitting in parallel with the valve stem fitting. In some embodiments, the device further comprises an air hose connectable to the female air fitting and connectable to a valve on a tire.

In some embodiments, the pressure gauge is certified and calibrated.

In some embodiments, the isolation valve comprises a ball valve.

In some embodiments, the isolation valve comprises a solenoid control valve.

### BRIEF DESCRIPTION OF THE DRAWINGS

FIG. 1 is line drawing of a pressure gauge testing device in accordance with one example embodiment of the present disclosure;

FIG. 2 is a line drawing of a pressure gauge testing device in accordance with one example embodiment of the present disclosure;

FIG. 3 is a line drawing of a pressure gauge testing device in accordance with one example embodiment of the present disclosure.

### DETAILED DESCRIPTION

To the accomplishment of the foregoing and related ends, certain illustrative aspects are described herein in connection with the following description and the annexed drawings. These aspects are indicative of the various ways in which the principles disclosed herein can be practiced. Other advantages and novel features will become apparent from the following detailed description when considered in conjunction with the drawings.

The pressure gauge testing device disclosed herein connects between an air source and a pressure gauge to test the accuracy of the pressure reading on the gauge.

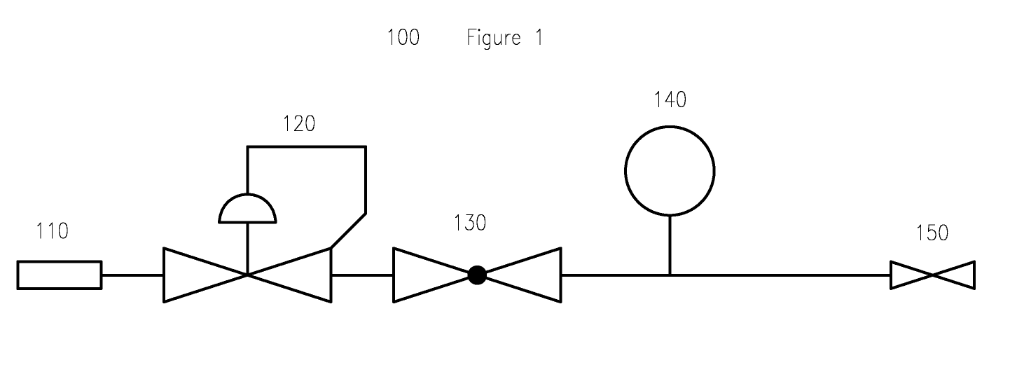

Referring to FIG. 1, the pressure gauge testing device 100 disclosed herein comprises an air supply inlet 110, a precision pressure regulator 120, an isolation valve 130 and a pressure gauge 140, and a valve stem fitting or connection 150. The air supply inlet 110 directs air from a pressurised air supply into the pressure regulator 120. An example of the air supply inlet is a male quick connect type M connector typically found in any service garage. The isolation valve 130 directs pressurised air out of the regulator to the pressure indication gauge 140. The pressure indication gauge should be a high accuracy, certified and calibrated pressure gauge. The valve stem fitting can be standard style tire valve stem. Pressure at the valve stem fitting 150 will match the output of the regulator 120 as displayed on the pressure gauge 140.

The pressurized air supply can be compressed oxygen or nitrogen or any other compressed gas as would be used for pressure in a pressurized device in an absolute pressure or gauge pressure value. The pressure can be measured using a metric, imperial or any other unit of measurement of pressure or vacuum state.

Thus, by using a tire pressure gauge on the valve stem fitting 150 to measure the pressure at the valve stem fitting and comparing the reading of the tire pressure gauge to the value of the pressure gauge 140 the accuracy of the tire pressure gauge can be determined. For example, one can increase the regulator 120 pressure to more values i.e. 50, 75 and 100 PSIG and record the reading from the tire pressure gauge for each pressure value on a record sheet. This record sheet will indicate how close the hand held tire gauge is reading compared to the certified pressure standard.

Non-limiting examples of regulators 120 that can be used, Parker P3RA302, P3RA102, P3RA102BP, Omega PRG200 series, and Control Air Inc Type 100,

In some embodiments the isolation valve 130 is a hand ball valve. Non-limiting examples of ball valves include Norgren Ball valve Full bore 602112128, DixionMS58 ball Valve, Apollo 77c Bronze Ball Valve, Full Port, Dixion reduce port Ball valve SSLBV2SP. In other embodiments the isolation valve is a pneumatically or electrically actuated solenoid control valve. The isolation valve must be able to stop air pressure from flowing in either direction. The isolation valve may be made from brass, stainless steel or other metal.

Non-limiting examples of the pressure gauge 140 that can be used, DG25 Ashcroft, D1005PS Pressure gauge, Crystal 3KPSIXP21 pressure gauge, Omega DPG5600B pressure gauge, and Fluke 700G06 pressure gauge.

In some embodiments, the air inlet 110 is a standard automotive type M quick connect fitting. In other embodiments the air inlet can be a threaded pipe with imperial or metric thread to work with the existing pipe. The connection to the existing pipe can also be welded, soldered or glued. The pipe can be ¼ inch ⅜ inch ½ inch etc. or metric sizes. The pipe and fitting may be brass, stainless steel or other metal. The air inlet needs to be able to safely contain the supply air pressure. All parts need to be rated for Compressed air use rated for the required pressures to do the testing.

To use the disclosed pressure gauge testing device 100, first, connect an air supply to the air inlet 110 of the device 100. In one embodiment, a standard automotive type M quick connect fitting is used to connect the air supply to the instrument. It is to be understood that any connection or quick connect fitting approved for pressure can be used. In some embodiments, the air supply is permanently connected to this air supply. An air filter is recommended up stream on this device if the air supply has oil or water or dirt in it.

Next with the pressure gauge 140 turned on and reading zero and the isolation valve 130 open increase the pressure regulator 120 value to indicate (i.e. 25.0 PSIG) on the pressure gauge's 140 display. Once the pressure display is reading this pressure, connect the pressure gauge to be tested to the valve stem fitting 150 and read the value on the pressure gauge to be tested. Record the value on the pressure gauge being tested on a service record sheet.

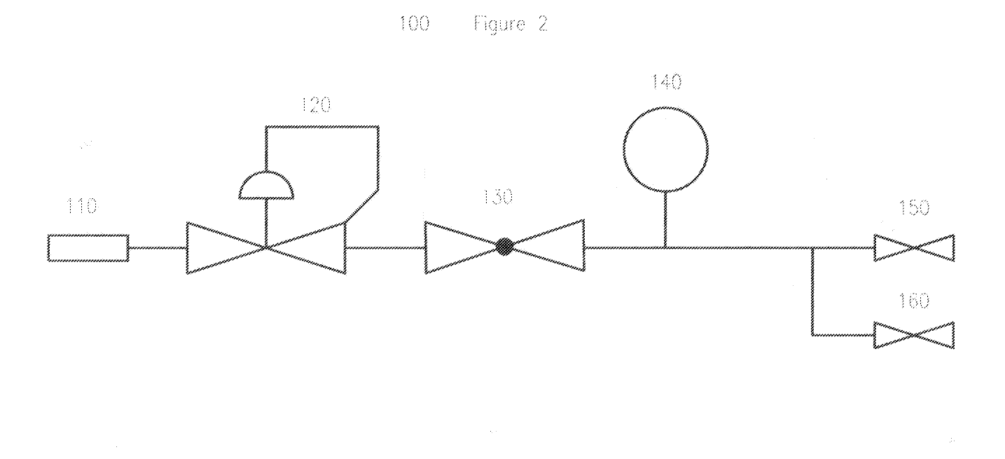

Another application of the pressure gauge testing device 100 will now be described with reference to FIG. 2. The device 100 in this embodiment comprises a female fitting 160 in parallel with the valve stem fitting 150. To test the tire pressure directly, close the isolation valve 130 and connect a shop portable airline hose to the female quick connect fitting 160. Then, connect the tire valve stem to the other end of the shop portable airline hose. The pressure gauge 140 will indicate the tire pressure directly.

The automobile industry has been installing Tire Pressure Monitoring Systems (TPMS) for years. This system is used to monitor tire pressure over or under inflation. The idea is to warn of a tire pressure problem. These include under inflation as it affects control of steering and braking, fuel economy and tire wear. Many of these same conditions occur with over inflation. Many lives have been lost and permanently injured due to these inflation conditions, as well as car damage.

Typical TPMS are designed to warn of a tire issue at 25% or normal pressure based on manufacturer's specifications. As an example, the driver of a passenger car that calls for 35 psi may not be warned about tire pressure loss until it drops to 26 psi depending on the type of monitoring system used. Under the same circumstances, a driver of a light truck that calls for 80 psi won't be warned until just 60 psi remains. In both of these cases, significant load capacity has been sacrificed before the driver is warned.

The disclosed pressure gauge testing device 100, when connected in the manner described in the second embodiment described with reference to FIG. 2, can be used to verify the TPMS sensor is correctly measuring the tire pressure.

When connected to the tire as described in FIG. 2 and using a tire sensor reader, data from the tire sensor will indicate the tire pressure via the tire sensor reader. This information can be compared to the certified pressure gauge 140 and recorded.

To be a certified pressure gauge 140, the pressure gauge 140 must be tested and certified to be within the manufactures specifications and accuracy. The pressure calibration standard must be traceable to the National Research Council of Canada or the National Institute of Standards and Technology (NIST) in the United States and be 4 times-10 times more accurate than the pressure gauge 140. This process is completed at least annually to maintain the accuracy of the pressure gauge 140.

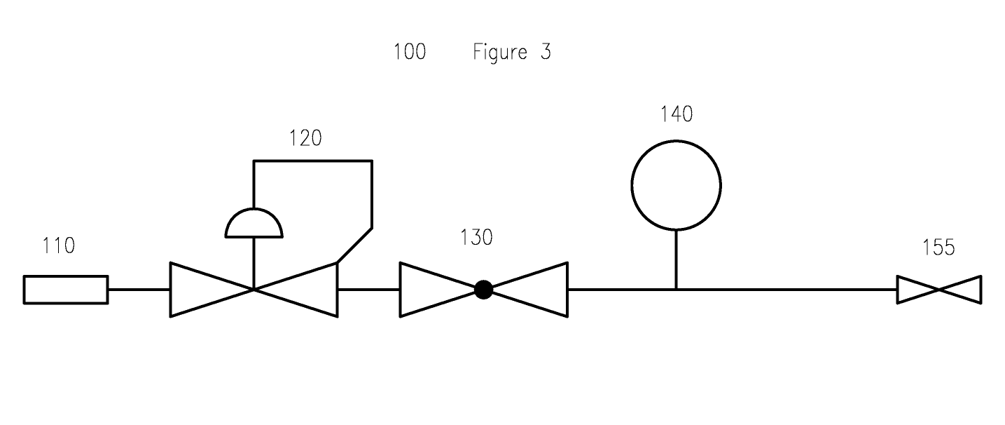

Referring to FIG. 3, in yet another configuration, the valve stem fitting 150 can be replace with a quick connect fitting 155. In this configuration, the device 100 can be connected to a converter with a valve stem fitting to be used as described with reference to FIG. 1 or can be used as a tool to both source and measure the control air signals and systems. In the field of process/control instrumentation, there are times when in troubleshooting an air control system (air actuator on a control valve); a regulated air supply can be used to simulate the air signal from the control system.

When trouble shooting an air control, the disclosed device can be used to simulate the control system air input to the actuator. Non-limiting examples of the air control stem are an Air to open control system and an air to close control system. The systems can be 3-15 psig systems or other pressure depending on the regulator used in the testing device. In some embodiments, the air control system comprises an air actuated control valve. To simulate the air signal, connect the device inlet 110 to an air supply and the output connection 155 to the input of the actuator, with the ball valve 130 open, and adjust the regulator 120 to increase the pressure as displayed on the pressure gauge 140 and output 155 to the actuator. One non-limiting example would be to adjust the regulator 120 to 3 psig. This should see the actuator stay in the non-actuated state. As the regulator 120 value is increased, the pressure gauge 140 will indicate the new pressure as it is adjusted up to 15 PSIg. The actuator should travel from non-actuated state to the fully actuated state. This is commonly referred to as stoking the valve or actuator. This test would confirm if the actuator is functioning correctly. It can be used to detect whether there is an internal problem with the actuator spring, diaphragm, valve stem sticking or other issue.

Using the device shown in FIG. 3 to test the control air signal would be as follows: Close the ball valve 130; Connect the control air signal, typically 3-15 PSIg, to the connection 155; and Adjust the control air signal and read the value of the air signal on the pressure gauge 140. One can compare the air pressure expected from control system to what is actually being output from the control system via pressure gauge 140. This test is very useful to determine if the control system is applying the correct air signal to the control device (e.g. actuator for a control valve).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations. Furthermore, to the extent that the term “includes” is used in either the detailed description or the claims, such term is intended to be inclusive in a manner similar to the term “comprising” as “comprising” is interpreted when employed as a transitional word in a claim.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1. A pressure gauge testing device comprising:
an air supply inlet;
a pressure regulator connected to the air supply inlet;
an isolation valve connected to the pressure regulator;
a air connection fitting connected to the isolation valve; and
a pressure gauge for reading the pressure between the isolation valve and the valve stem fitting.

2. The testing device of claim 1 wherein the air supply inlet comprises a quick connect connector.

3. The testing device of claim 1 wherein the air supply inlet comprises an automotive type M quick connect connector.

4. The testing device of claim 1 wherein the air supply inlet is a threaded pipe.

5. The testing device of claim 1 wherein the air inlet comprises a connecter rated for at least 100 PSIg.

6. The testing device of claim 1 wherein the air connection fitting is a valve stem fitting.

7. The testing device of claim 6 further comprising a female air fitting in parallel with the valve stem fitting.

8. The testing device of claim 7, further comprising an air hose connectable to the female air fitting and connectable to a valve on a tire.

9. The testing device of claim 1 wherein the air connection fitting is a quick connect fitting.

10. The testing device of claim 1 wherein the pressure gauge is certified and calibrated.

11. The testing device of claim 1 wherein the isolation valve comprises a ball valve.

12. The testing device of claim 1 wherein the isolation valve comprises a solenoid control valve.
